(19) United States
(12) Patent Application Publication
(10) Pub. No.: US 2016/0118650 A1
(43) Pub. Date: Apr. 28, 2016

(54) CORE-SHELL TYPE ANODE ACTIVE MATERIAL FOR LITHIUM SECONDARY BATTERIES, METHOD FOR PREPARING THE SAME AND LITHIUM SECONDARY BATTERIES CONTAINING THE SAME

(71) Applicant: SOLVAY SPECIALTY POLYMERS ITALY S.P.A., Bollate (IT)

(72) Inventors: Paula COJOCARU, Legnano (IT); Marco APOSTOLO, Senago (IT); Frederic FOUDA-ONANA, St-Egrève (FR)

(21) Appl. No.: 14/895,341

(22) PCT Filed: Jun. 3, 2014
(86) PCT No.: PCT/EP2014/061504

§ 371 Date: Dec. 2, 2015

(30) Foreign Application Priority Data
Jun. 4, 2013 (EP) 13170517.0

(51) Int. Cl. H01M 4/36; H01M 4/62; H01M 4/60; H01M 4/38; H01M 4/04; H01M 4/133; H01M 4/134; H01M 4/1393; H01M 4/1395; H01M 10/052; H01M 4/587

(52) U.S. Cl. CPC H01M 4/366; H01M 10/052; H01M 4/622; H01M 4/602; H01M 4/386; H01M 4/587; H01M 4/364; H01M 4/626; H01M 4/133; H01M 4/134; H01M 4/1393; H01M 4/1395; H01M 4/0404; H01M 4/0409; H01M 4/049; H01M 2004/027

(57) ABSTRACT

The invention pertains to a core-shell type anode active material for lithium secondary batteries, comprising: a core made of a silicon-containing electroactive material; and a metallic shell formed outside the core, wherein the metallic shell is composed of at least one metallic compound comprising at least one metal [compound (M)]. The invention further discloses a method for manufacturing said core-shell type anode active material, which uses electroless plating. Additionally, the invention also relates to a process for manufacturing an anode structure using the core-shell type anode active material, and to an electrochemical device comprising said anode structure.

### CROSS-REFERENCE TO RELATED APPLICATION

The present application claims priority to European application No. 13170517.0 filed on Jun. 4, 2013, the whole content of this application being incorporated herein by reference.

### TECHNICAL FIELD

The present invention relates to a core-shell type anode active material for lithium secondary batteries, a method for preparing the same and electrochemical devices comprising the same. Particularly, the present invention pertains to a core-shell type anode material for lithium secondary batteries, which comprises a core made of a silicon-containing electroactive material and a metallic shell formed outside the core, and a method for producing the same.

### BACKGROUND ART

Currently, typical anode materials used in commercial lithium ion batteries are consisted of carbonaceous materials, such as graphite, which is considered inexpensive and safe to use. However, with a theoretical charge capacity of 370 mA hg⁻¹, graphite material provides lower energy capacity compared to other anode materials such as lithium alloys with silicon, tin, antimony, or germanium, among which silicon is especially attractive for its high theoretical charge capacity of 4200 mA hg⁻¹. Moreover, anodes made of graphite material are known to have the drawback of low reversible capacity, and undesired reduction in charge/discharge efficiency after a few charge-discharge circles.

Therefore, there has been intense interest in finding alternative anode active material to meet the need of an ideal lithium battery: one that features high energy capacity, good stability and also safe to use. Noticeably, researchers have proposed two possible means to reach this goal: by proper combination of different anode materials or by pre-conditioning of the available carbon-based electrode.

For instance, XING, Weibing, et al. Pyrolyzed Polysiloxanes for Use as Anode Materials in Lithium-Ion Batteries. J. Electrochem. Soc. 1997, vol. 144, no. 7, p. 2410-2416. tested the possibility of using a pyrolyzed polysiloxane anode material, and concludes that optimized silicon-containing carbons may be good alternatives to pure carbons in a lithium battery anode, by providing a higher charge capacity. Nevertheless, in the tested pyrolyzed polysiloxane anode materials, the proportion of silicon, carbon and oxygen needs to be finely tuned to avoid poor electrochemical performance. Moreover, even though XING, Weibing, et al found certain pyrolyzed polysiloxane anode materials which could provide higher reversible capacity in a lithium-ion battery, as compared to pure carbon, this advantage is provided at a price of larger irreversible capacities and larger charge-discharge voltage hysteresis, both considered unfavourable properties for a commercial lithium-ion battery.

As a different approach to modify the existing carbon-based anodes, US 2011/0244322 A (KOKAM CO. LTD) 6 Oct. 2011 discloses a core-shell type anode active material for lithium batteries, which includes a carbonaceous material core and an outer shell comprising a PTC (positive temperature coefficient) medium such as barium titanate. Similarly, EP 2450988 A (KOKAM CO., LTD) 9 May 2012 describes another core-shell anode material having a carbon core and an outer shell comprising spinel type lithium titanium oxide particles and other metal oxide particles, and KR 101105877 B (KOKAM CO LTD) 20 Dec. 2010 describes yet another core-shell anode material having a carbon core and a shell made of a mixture of aluminium oxide powder, titanium dioxide powder and conductive additives, wherein the shell is formed by dry coating.

Moreover, US 2012202112 A (SILA NANOTECH NOLOGIES INC; GEORGIA TECH RES INST) 9 Aug. 2012 discloses an anode material which has a silicon core and a protective shell including a polymer, a metal oxide, a metal fluoride, a carbon, or a combination thereof, wherein the coating may be performed by physical vapor deposition, chemical vapor deposition, magnetron sputtering, atomic layer deposition, microwave-assisted deposition, wet chemistry coating and the like.

Further, QI, Yue, et al. CoO/NiSix core-shell nanowire arrays as lithium-ion anodes with high rate capabilities. Nanoscale. 2012, vol. 4, no. 3, p. 991-996. describes the use of a CoO/NiSiₓ core-shell type nanowire array as a lithium battery anode, which has a metallic core of NiSiₓNWₛ and an outer layer of CoO, wherein the outer layer is deposited on the core surface thorough a radio frequency—sputtering method.

However, these coated anode materials are not ideal replacement for the existing carbon-based anodes, due to their divergent coating porosity that is detrimental to the battery power.

In an attempt to address the above issue, US 20060147790 A (HYDRO-QUEBEC) 6 Jul. 2006 provides a process for preparing an electrode material containing a graphite nucleus and an outer layer with a different material, the process including crushing together the particles intended to constitute said nucleus and its outer layer, for instance by mechano-melting at a predetermined rotation speed. While US 20060147790 claims that the electrode material thus obtained could be advantageously used in electrochemical batteries and provides operating safety, the aggressive mechanical crushing process it relies on cannot ensure a homogenous surface coating or a good control of coating thickness on the graphite nucleus, which will dampen the stability of desired battery performance.

A need therefore exists for finding a better process to allow the preparation of improved anode materials for lithium battery, which avoids the disadvantages of the above discussed prior art.

### BRIEF DESCRIPTION OF DRAWINGS

FIG. 1 illustrates an anode structure having the anode-forming composition (A) according to the invention applied on both surfaces of an electroconductive substrate.

FIG. 2 illustrates an anode structure having the anode-forming composition (A) according to the invention applied on one surface of an electroconductive substrate.

### SUMMARY OF INVENTION

To solve the above-mentioned prior art problems, it is an object of the invention to provide a novel, improved anode active material for lithium secondary batteries, as well as a method which enables manufacturing of a core-shell type anode active material with excellent electrochemical properties and structural stability.

Therefore, a first aspect of the present invention is to provide a core-shell type anode active material for lithium secondary batteries, which comprises:
a core made of a silicon-containing electroactive material; and
a metallic shell formed outside the core, wherein the metallic shell is composed of at least one metallic compound comprising at least one metal [compound (M)].

The Applicant has surprisingly found that, by providing an anode structure made from the core-shell type anode active material as above detailed, a lithium secondary battery with excellent electrochemical properties and superior structural stability during charge-discharge cycling can be manufactured.

In the second aspect of the present invention, there is provided a method for manufacturing a core-shell type anode material of any one of the preceding claims, wherein the method uses electroless plating for forming the metallic shell outside the core.

The Applicant has surprisingly found that when using the method as above detailed, effective manufacturing of an improved core-shell type anode material is enabled without impairment of the stability of associated battery performance.

For the purpose of the present invention, the term “electroactive material” intends to denote an electroactive particulate material which actively participates in the underlying redox reaction during charge/discharge phenomena of a secondary battery. By the term “silicon-containing electroactive material” it should be understood to mean an electroactive particulate material which includes silicon within its structure.

The silicon-containing electroactive material can comprise silicon having a purity of greater than 90%. The silicon containing electroactive material suitably has a purity of less than 99.99%. Preferably, the silicon-containing electroactive material comprises silicon having a purity in the range of 95 to 99.99%, more preferably 99.90% to 99.99% and especially 99.95% to 99.99%.

The silicon-containing electroactive material can include alloys of silicon with a metal different from lithium, such as copper and iron, provided the metal does not inhibit the insertion and release of charge carriers such as lithium into the alloyed silicon during the charging and discharging phases of the battery.

In one specific embodiment, said core-shell type anode active material has a core consisting essentially of silicon. As used herein, the phrase “consisting essentially of” denotes a core made of silicon and optionally minor amounts of other components which do not affect the electrochemical properties of silicon.

In another embodiment of the core-shell type anode active material according to the invention, the silicon-containing electroactive material is a mixture of silicon and at least one carbonaceous material. Preferably, said carbonaceous material is selected from graphitic carbons which are able to intercalate lithium, typically existing in forms such as powders, flakes, fibers or spheres (for example, mesocarbon microbeads) hosting lithium. More preferably, the silicon-containing electroactive material is a mixture of silicon and graphite, which is found to contribute to the formation of an anode structure with superior electrochemical properties over charge-discharge cyclings.

Further, in a core-shell type anode active material according to the present invention, a metallic shell is formed outside the core, wherein the metallic shell is composed of at least one compound (M).

In one embodiment of the core-shell type anode active material according to the present invention, said metallic shell forms an outer layer at least partially surrounding the core. Preferably, the outer layer completely surrounds (e.g., encapsulating) the core. Still, it is possible to have a core only partially covered by the outer layer, leaving a portion of the core exposed.

The compound (M) can be selected from a group consisting of Rh, Ir, Ru, Ti, Re, Os, Cd, TI, Pb, Bi, In, Sb, Ti, Cu, Ni, Pd, V, Fe, Cr, Mn, Co, Zn, Mo, W, Ag, Au, Pt, Ir, Ru, Pd, Sn, Ge, Ga. Preferably, the compound (M) is selected from a group consisting of Cu, Ag, and Ni. More preferably the compound (M) is Cu, Ag or an alloy of Ag and/or of Cu, even more preferably the compound (M) is Cu.

In one preferred embodiment of the core-shell type anode active material according to the present invention, the metallic shell is consisting essentially of Cu.

In accordance with the present invention, said metallic shell may be formed outside the core in the core-shell type anode active material using any conventional methods known in the art.

Among said methods mention can be made of ‘dry’ processes, not involving contact of the core with a liquid phase, including notably evaporation techniques such as chemical vapour deposition, thermal evaporation, ion beam evaporation, filament evaporation, vacuum deposition, and sputtering techniques.

As an alternative, methods suitable can involve the contact of the core with a liquid phase, including coating, impregnation or dipping techniques. Among those techniques, electroplating and electroless plating techniques are particularly suitable, with electroless plating techniques being preferred.

In electroplating, an ionic precursor of compound (M) is supplied with electrons to form a non-ionic coating. A common system involves an electrolytic cell comprising a solution with said ionic precursor of compound (M), an anode which may consist of the metal being plated (a soluble anode) or an insoluble anode (usually carbon, platinum, titanium, lead, or steel), and finally, a cathode (negatively charged) where electrons are supplied to produce a film of non-ionic metal.

Electroless plating, also known as chemical or auto-catalytic plating, is a non-galvanic type of plating method; according to said technique, a soluble precursor of compound (M) is provided in an electroless plating medium containing particles of said silicon-containing electroactive material, in the additional presence of a suitable agent inducing plating of the compound (M) onto said particles.

The electroless plating medium can be aqueous or non aqueous; nevertheless, aqueous electroless plating media are typically used.

To the aim of electroless plating an outer layer of Copper, generally, a plating bath comprising sodium hydroxide, formaldehyde, a chelating agent (e.g. EDTA), and a copper salt (generally a Cu+II salt, such as copper (+II) sulphate) are used. Palladium is often used as catalyst and can be preliminarily impregnated onto the particles of compound (E). Without being bound by this theory, it is generally understood that in the complex reaction, possibly catalyzed by palladium, formaldehyde reduces the copper ion to metallic copper.

According to the second aspect of the invention, there is provided a method for manufacturing a core-shell type anode material as above detailed, wherein the method uses electroless plating for forming the metallic shell outside the core.

Specifically, the aforementioned method may comprise the steps of:
(i) providing an aqueous electroless plating medium containing particles of the silicon-containing electroactive material as above detailed; and
(ii) introducing a soluble precursor of compound (M) in the aqueous electroless plating medium provided in step (i).

The electroless plating process, the selection of compound (M) in the above methods is as described in the foregoing text.

Another object of the present invention is an anode-forming composition [composition (A)] comprising particles of at least one core-shell type anode active material as above detailed. The composition (A) may further comprise at least one polymer binder. The composition (A) may be an aqueous anode-forming composition further comprising water and at least one polymer binder. Alternatively, the composition (A) may be an non-aqueous anode-forming composition further comprising an non-aqueous solvent and at least one polymer binder.

The choice of the at least one polymer binder in the composition (A) is not particularly limited. For instance, said polymer binder may be a fluoropolymer as described in WO 2013/037692 (SOLVAY SPECIALTY POLYMERS ITALY S.P.A.).

The composition (A) can additionally comprise at least one electroconductivity-imparting additive. Said additive is generally added in an amount of 0.5 to 15% wt, preferably 0.75 to 12.5% wt, more preferably of 1 to 10% wt, with respect to the total weight of the composition. Non-limitative examples of suitable electroconductivity-imparting additives include, notably, carbon black, graphene or carbon nanotubes and powders and fibers of metals, such as nickel and aluminum.

The composition (A) can also additionally comprise at least one carbonaceous material. Preferably, said carbonaceous material is selected from graphitic carbons which are able to intercalate lithium, typically existing in forms such as powders, flakes, fibers or spheres (for example, mesocarbon microbeads) hosting lithium.

The composition (A) may further comprise at least one chemical additive selected from the group consisting of polyelectrolytes, carboxylated alkyl cellulose like carboxylated methyl cellulose, natural clays like montmorillonite and bentonite, and manmade clays like laponite, silica and talc.

Polyelectrolytes suitable for use in the composition (A) of the invention are typically polymers comprising recurring units comprising at least one ionisable group. The polyelectrolyte is preferably soluble in water.

The ionisable group of the recurring units of the polyelectrolyte may be a cationic group (i.e. a group leading in ionised form to a positive charge in the recurring unit) or an anionic group (i.e. a group leading in ionised form to a negative charge in the recurring unit).

Cationic-type polyelectrolytes typically consist essentially of recurring units comprising at least one ionisable group selected from the group consisting of amine groups and imine groups. Non limitative examples of cationic-type polyelectrolytes include notably poly(ethyleneimine)s, polyvinylpyridines, poly(lysine)s, poly(dimethylaminoethyl acrylate)s.

Anionic-type polyelectrolytes typically consist essentially of recurring units comprising at least one ionisable group selected from the group consisting of carboxylic acid (—COOH), sulfonic acid (—SO₃H) and phosphonic acid (—PO₃H₂) groups. Non limitative examples of anionic-type polyelectrolytes include notably poly(meth)acrylic acids, poly(styrene sulfonic acid)s, poly(glutamic acid)s, poly(vinylsulfate)s.

Typically, cationic-type polyelectrolytes will be used in the composition (A) of the invention in their “neutral” form, while anionic-type polyelectrolytes will be used in the composition (A) of the invention in their salified form.

Polyelectrolytes which have been found particularly suitable for use in the composition (A) of the present invention are anionic-type polyelectrolytes.

The polyelectrolyte generally complies with formula:

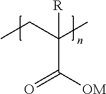

wherein M is an ammonium group or an alkaline metal cation (preferably Na⁺), R being H or —CH₃, and n being an integer such that the number-averaged molecular weight of the polyelectrolyte is of from 1000 to 10000, preferably of 2000 to 8000, more preferably of 3000 to 5000.

The composition (A) preferably further comprises at least one chemical additive selected from the group consisting of polyelectrolytes, carboxylated alkyl cellulose like carboxylated methyl cellulose, natural clays like montmorillonite and bentonite, and manmade clays like laponite, silica and talc, typically in a range between 0.1% and 10% by weight, preferably between 0.5% and 5% by weight, with respect to the total weight of the composition (A).

Said chemical additive may act as a thickener (also designated as rheology modifier), which is generally added in order to prevent or slow down the settling of the powdery electrode material from the composition (A), while providing appropriate viscosity for a casting process. Moreover, when said chemical additive is carboxylated alkyl cellulose like carboxylated methyl cellulose, such may also act as a polymer binder in the composition (A).

Preferred polymer binders for the composition (A) include: carboxylated alkyl cellulose, preferably a carboxylated methyl cellulose; polyamide imides; and polyimides.

The composition (A) more preferably further comprises at least one chemical additive selected from the group consisting of polyelectrolytes, preferably from the group consisting of anionic-type polyelectrolytes such as partially neutralized poly(acrylic acid) or poly(methacrylic acid), typically in a range between 0.1% and 10% by weight, preferably between 0.5% and 5% by weight, with respect to the total weight of the composition (A).

Should the composition (A) further comprise at least one chemical additive selected from the group consisting of polyelectrolytes, preferably from the group consisting of anionic-type polyelectrolytes such as partially neutralized poly(acrylic acid) or poly(methacrylic acid), said composition (A) preferably also comprises at least one polymer binder, said polymer binder being preferably a carboxylated alkyl cellulose, more preferably a carboxylated methyl cellulose.

Typically, the composition (A) is an aqueous solution which further comprises water and at least one chemical additive, preferably at least one chemical additive selected from the group consisting of polyelectrolytes, more preferably at least one chemical additive selected from the group consisting of anionic-type polyelectrolytes such as partially neutralized poly(acrylic acid) or poly(methacrylic acid), typically in a range between 0.1% and 10% by weight, preferably between 0.5% and 5% by weight, with respect to the total weight of the composition (A).

Preferably, the composition (A) is an aqueous solution which comprises water and at least one polymer binder. Optionally, the aqueous composition (A) can additionally contain one or more fugitive adhesion promoters as described in US 2010/0304270 A (ARKEMA INC) 2 Dec. 2010. As used herein, the term “fugitive adhesion promoter” is intended to denote an agent that increases the interconnectivity of the aqueous composition (A) after coating on a substrate. The fugitive adhesion promoter is then capable of being removed from the formed electrode generally by evaporation (for a chemical) or by dissipation (for added energy).

The fugitive adhesion promoter can be a chemical material, an energy source combined with pressure, or a combination, used at an effective amount to cause interconnectivity of the components of the aqueous composition (A) during formation of the electrode. For chemical fugitive adhesion promoters, the aqueous composition (A) contains 0 to 150 parts, preferably 1 to 100 parts, and more preferably from 2 to 30 parts, of one or more fugitive adhesion promoters by weight per 100 parts by weight of water. Preferably this is an organic liquid that is soluble or miscible in water. In one embodiment a useful organic solvent is N-methyl-2-pyrrolidone. Other useful fugitive adhesion promoter agents include, but are not limited to, dimethylformamide, N,N-dimethylacetamide, dimethylsulfoxide (DMSO), hexamethylphosphamide, dioxane, tetrahydrofuran, tetramethylurea, triethyl phosphate, trimethyl phosphate, dimethyl succinate, diethyl succinate and tetraethyl urea.

In the case of energy as the fugitive adhesion promoter, useful energy sources include, but are not limited to, heat, IR radiation, and radio frequency (RF). When energy alone is used as the fugitive adhesion promoter, it is preferred that the heat is combined with pressure—such as a calendering step, for good interconnectivity.

The aqueous composition (A) may comprise, in addition to water, at least one additional liquid solvent, preferably selected from the group consisting of polar organic solvents. Said polar organic solvent is generally selected from the group consisting of ethanol, N-methyl-2-pyrrolidone, N,N-dimethylformamide, N,N-dimethylacetamide, dimethylsulfoxide, hexamethylphosphamide, dioxane, tetrahydrofuran, tetramethylurea, triethyl phosphate, and trimethyl phosphate, and may be used singly or in mixture of at least two species. Generally, if at least one additional liquid solvent is present in the aqueous composition (A), water represents at least 50% wt, preferably at least 75% wt, more preferably at least 80% wt, with respect to the total weight of water and the additional liquid solvent.

Still another object of the present invention is a process for manufacturing an anode structure using the composition (A). Advantageously, said process comprises applying the composition (A) onto at least one surface of a substrate, preferably of a metal substrate.

The composition (A) may be applied by any conventional wet coating process. Particularly, as non-limiting examples, the wet coating process may include screen printing, coating using a roll coater, a blade coater, a slit coater, a curtain coater, a wire coater, a sprayer, a foam applicator, a brush coater and the like.

The drying process for the composition (A) to form the stable coating layer may be selected from known technologies. As a non-limiting example, the drying may be performed at a temperature ranging from room temperature to 150° C. As specific, non-limiting embodiments, the drying temperature may range from room temperature to 100° C.

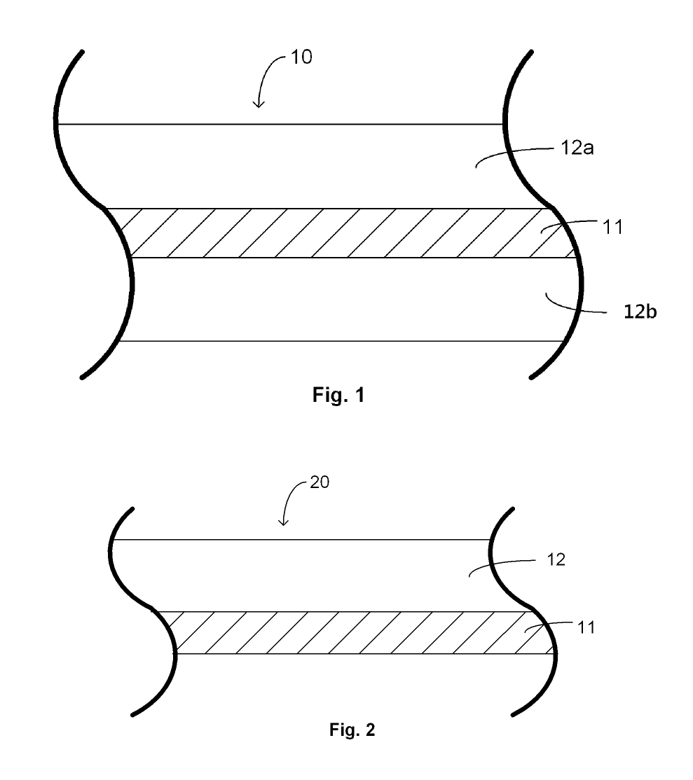

The composition (A) may be used for forming anode structures having different partial sectional structures as shown in FIG. 1 and FIG. 2. More specifically, the composition (A) may be applied onto both surfaces (FIG. 1) or one surface (FIG. 2) of an electroconductive substrate 11 comprising a foil or wire net of a metal, such as iron, stainless steel, steel, copper, aluminum, nickel or titanium and having a thickness of, e.g., 5-100 μm, or 5-20 μm for a small-sized device, and dried to form a composite electrode layer (12a, 12b or 12) of, e.g., 10-1000 μm in thickness for a small-sized device, thereby providing an anode structure (10 or 20).

Alternatively, it is also possible to form an anode structure similar to the one shown in FIG. 1 or FIG. 2 by once forming a composite electrode layer 12 as shown in FIG. 2 on an electroconductive substrate 11 or an arbitrary substrate having a better releasability by application and drying, then peeling only the composite electrode layer 12 apart from the substrate to obtain an electrode sheet, and then applying the electrode sheet onto an electroconductive substrate 11 with an electroconductive adhesive by a manufacturer of an electrochemical device, such as a battery.

The thus-formed anode structure 10 or 20 may preferably be used as an anode for a battery or an electric double layer capacitor wherein it is used in the state of being dipped in a non-aqueous electrolytic solution.

Yet another object of the present invention is an anode structure made from a core-shell type anode material as above detailed, preferably from the composition (A).

Further, the anode structure according to the present invention, preferably in the form of an anode structure 10 (FIG. 1) having composite electrode layers 12a and 12b on both sides, may be used as a negative electrode of a non-aqueous battery, particularly a lithium ion battery.

More generally, the anode structure as above detailed can be used in any electrochemical devices. The use of the anode structure, as above detailed, in electrochemical devices, including notably non-aqueous batteries, e.g. lithium ion batteries, and capacitors, in particular electric double layer capacitor, is another object of the present invention.

Should the disclosure of any patents, patent applications, and publications which are incorporated herein by reference conflict with the description of the present application to the extent that it may render a term unclear, the present description shall take precedence.

The invention will be now described in more details with respect to the following examples, whose purpose is merely illustrative and not intended to limit the scope of the invention.

### EXAMPLE

### Raw Material

Silicon (Si) powder: commercial grade supplied by SkySpring Nanomaterials Inc.
Graphite: TIMREX SLP30 from TimCal Ltd., Switzerland.
Carbon black: Super P from Timcal AG
Sodium carboxymethyl cellulose from Sigma Aldrich
Polyacrylic acid from Sigma Aldrich

### Preparative Example 1

### Electroless Coating of Si Particles with Copper

In this preparative Example, particles of Si were coated with Copper (Cu) via electroless plating in accordance with the following procedure. Firstly, the plating was initiated by depositing a palladium (Pd) catalyst on the Si particle surface. The Pd catalyst deposition was performed by immersing a powder of Si particles in an aqueous solution containing 0.03 g/L of PdCl₂, for one minute, which resulted in Si particles covered with Pd at a high density.

The Pd-catalyzed Si powder was then immersed in an aqueous plating bath under magnetic stirring at a speed of 200 rpm. Said aqueous plating bath contained 6 g/L copper sulphate, 27 g/L EDTA, 7.47 mL/L formaldehyde and 5.6 g/L sodium hydroxide, and had a pH value of 12. The plating temperature was set to be 60° C. After 30 minutes of immersion, Cu-coated Si material was successfully obtained.

### Example 2

### Manufacture of an Anode Using Cu-Coated Si Material

An anode was prepared using Cu-coated Si material obtained in Preparative Example 1, following the procedure below:
1 gram of Cu-coated Si material obtained from Preparative Example 1 was dry-mixed by a mortar with 0.2 gram of graphite SLP30 and 2.4 gram of carbon black Super P. When a homogenous powdery mixture was achieved, it was added slowly to a solution composed by 8 gram of 4 wt % Sodium carboxymethyl cellulose water solution, 228 mg of 35 wt % acrylic acid water solution and 3.5 gram of 25/75 w/w ethanol/water solution. The resulting composite slurry was mechanically stirred at 1000 rpm for 30 minutes. The paste was thereafter tape casted with a Dr. Blade casting equipment on a 10 μm thick copper foil using a knife for 100 μm coating. The electrode was thereafter dried at room temperature during daytime and then placed in a vacuum oven at 90° C. to dry overnight. The final anode has a thickness of 81 μm and a loading of 2.4 mg of electrode material per square cm.

### Comparative Example 3

### Manufacture of an Anode Using Uncoated Si Particles

An anode was prepared following the same procedure as detailed in Example 2, except for using the un-coated Si powder of commercial grade as starting material.

### Example 4

### Evaluation of Electrochemical Properties for Manufactured Anodes of Example 2 and Comparative Example 3

Lithium coin cells (CR2032 type) were prepared in a glove box under Ar gas atmosphere by punching a small disk of the electrode prepared according to Example 2 and Comparative Example 3 together with Lithium metal as counter and reference electrode. The electrolyte was 1 M LiPF₆ in ethylene carbonate (EC)/dimethylcarbonate (DMC) (1:1 vol/vol) and a Whatman® glass-fiber paper was used as separator.

After initial charge and discharge cycles at a low current rate, each of the two cells was galvanostatically cycled at a constant current rate of 0.2 C. As seen from the data in Table 1 and Table 2, the cell using anode of Comparative Example 3 exhibited significantly larger capacity fade with cycling, compared to the cell using anode of Example 2. These electrochemical results also indicated that, by an electroless deposition of Cu coating on the Si active anode material, a superior anode (Ex. 2) with better structural stability over cycling can be produced, as evidenced by a notably improved capacity retention over the anode using uncoated Si active material (Comp. Ex. 3).

TABLE 1

| | Initial | RC¹ after 6 | Capacity |
|---|---|---|---|
| | RC¹ | cycles | Retention² |
| Anode | (mAh/g) | (mAh/g) | (%) |
| Ex. 2 | 962 | 737 | 76.6 |
| Comp. Ex. 3 | 959 | 574.5 | 60 |

¹RC: Reversible Capacity;
²Capacity retention: determined after 6 cycles.

TABLE 2

| | CC³ after 30 | AC⁴ per cycle |
|---|---|---|
| Anode | cycles (mAh/g) | (mAh/g/cycle) |
| Ex. 2 | 16304 | 543.7 |
| Comp. Ex. 3 | 13284 | 442.8 |

³CC: Cumulative Capacity, determined after 30 cycles;
⁴AC: Average Capacity.

### Example 5

### Manufacture of an Anode Using Cu-Coated Si Material

An anode was prepared using Cu-coated Si material obtained in Preparative Example 1, following the procedure below:
1 gram of Cu-coated Si material obtained from Preparative Example 1 was dry-mixed by a mortar with 0.23 gram of carbon black Super P. When a homogenous powdery mixture was achieved, it was added slowly to a solution composed by 1.2 gram of Sodium carboxymethyl cellulose (CMC), 0.2 gram polyacrylic acid (AA). The resulting composite slurry was mechanically stirred at 1000 rpm for 30 minutes. The paste was thereafter tape casted with a Dr. Blade casting equipment on a 10 μm thick copper foil using a knife for 100 μm coating. The electrode was thereafter dried at room temperature during daytime and then placed in a vacuum oven at 90° C. to dry overnight. The final anode has a thickness of 47 μm and a loading of 3 mg of electrode material per square cm.

### Comparative Example 6

### Manufacture of an Anode Using Uncoated Si Particles

An anode was prepared following the same procedure as detailed in Example 5, except for using the un-coated Si powder of commercial grade as starting material.

### Example 7

### Evaluation of Electrochemical Properties for Manufactured Anodes of Example 5 and Comparative Example 6

Lithium coin cells (CR2032 type) were prepared in a glove box under Ar gas atmosphere by punching a small disk of the electrode prepared according to Example 5 and Comparative Example 6 together with Lithium metal as counter and reference electrode. The electrolyte was 1 M LiPF₆ in ethylene carbonat (EC)/dimethylcarbonate (DMC) (1:1 vol/vol) and a Whatman® glass-fiber paper was used as separator. After initial charge and discharge cycles at a low current rate, each of the two cells was galvanostatically cycled at a constant current rate of C/5-D/5. As seen from the data in Table 3, the cell using anode of Comparative Example 6 exhibited significantly larger capacity fade with cycling, compared to the cell using anode of Example 5. These electrochemical results further confirmed that, by an electroless deposition of Cu coating on the Si active anode material, a superior anode (Ex. 5) with better structural stability over cycling can be produced, as evidenced by a notably improved capacity retention over the anode using uncoated Si active material (Comp. Ex. 6).

TABLE 3

| | Initial | DC¹ after 5 | Capacity |
|---|---|---|---|
| | DC¹ | cycles | Retention² |
| Anode | (mAh/g) | (mAh/g) | (%) |
| Ex. 5 | 2507 | 378 | 62 |
| Comp. Ex. 6 | 1230 | 200 | 35 |

¹DC: Delithiation Capacity;
²Capacity retention: determined after 6 cycles

### Example 8

### Conductivity Measurement for Manufactured Anodes of Example 5 and Comparative Example 6

Conductivity of anodes of Example 5 and Comparative Example 6 was measured using out-of-plane method and using a four-point probe from Jandel Co., Ltd. In the out-of-plane method, the anodes were sandwiched between two electrodes and a voltage was applied to this system, to measure the circulating current in the system. Sheet resistance of the anodes were also measured by a four-point probe (a Jandel Cylindrical Probe head), which contains four thin collinearly placed tungsten wires probes made to contact the anode sample under test. During the four-point probe test, a current I was made to flow between the outer probes, and a voltage V was measured between the two inner probes.

The sheet resistance of the sample was given by:

Rs=4.53×V/I

The volume resistivity Rv (in ohm cm) of the sample was related to Rs by:

Rv=Rs*thickness (cm).

The anode electrode composition of Example 5 consists of 74% Cu/coated Si, 16% Super P and 10% CMC/AA binder. The results of the conductivity measurement at room temperature (RT) are shown in Table 4.

TABLE 4

| | Conductivity | Conductivity |
|---|---|---|
| | (S/cm² | (S/cm² |
| Anode | at RT) ¹⁾ | at RT) ²⁾ |
| Ex. 5 | 1.66E−02 | 2854 |
| Comp. Ex. 6 | 1.03E−02 | 0.5 |

¹⁾ Out-of-plane method
²⁾ Jandel four-point probe method

1. An anode-forming composition (A) comprising:
particles of at least one core-shell type anode active material for lithium secondary batteries, said core-shell type anode active material comprising:
a core made of a silicon-containing electroactive material; and
a metallic shell formed outside the core, wherein the metallic shell is composed of at least one metallic compound comprising at least one metal [compound (M)]; and
at least one chemical additive selected from the group consisting of polyelectrolytes.

2. The anode-forming composition (A) of claim 1, wherein the chemical additive is selected from the group consisting of partially neutralized poly(acrylic acid) and poly(methacrylic acid).

3. The anode-forming composition (A) of claim 1, wherein the chemical additive is selected from the group consisting of partially neutralized poly(acrylic acid) and poly(methacrylic acid), in a range between 0.1% and 10% by weight, with respect to the total weight of the composition (A).

4. The anode-forming composition (A) of claim 1, further comprising at least one polymer binder.

5. The anode-forming composition (A) of claim 4, wherein the polymer binder is selected from the group consisting of: carboxylated alkyl cellulose; polyamide imides; and polyimides.

6. The anode-forming composition (A) of claim 4, wherein the polymer binder is a carboxylated alkyl cellulose.

7. The anode-forming composition (A) of claim 1, wherein said composition (A) is an aqueous anode-forming composition further comprising water.

8. The anode-forming composition (A) of claim 1, wherein the core consists essentially of silicon.

9. The anode-forming composition (A) of claim 1, wherein the silicon-containing electroactive material is a mixture of silicon and at least one carbonaceous material.

10. The anode-forming composition (A) of claim 1, wherein the metallic shell forms an outer layer at least partially surrounding the core.

11. The anode-forming composition (A) of claim 1, wherein compound (M) of the metallic shell is selected from the group consisting of Cu, Ag and Ni.

12. A method for manufacturing the anode-forming composition (A) of claim 1, the method comprising electroless plating the metallic shell on the core to form a core-shell type anode active material.

13. The method according to claim 12, wherein the electroless plating comprises:
introducing a soluble precursor of compound (M) to an aqueous electroless plating medium, the plating medium containing particles of a silicon-containing electroactive material.

14. A method for manufacturing an anode, the method comprising applying the anode-forming composition (A) of claim 1 onto at least one surface of a substrate.

15. An anode structure made from the anode-forming composition (A) of claim 1.

16. An electrochemical device comprising an anode structure according to claim 15.

17. The anode-forming composition (A) of claim 3, wherein the chemical additive is selected from the group consisting of partially neutralized poly(acrylic acid) and poly(methacrylic acid), in a range between 0.5% and 5% by weight, with respect to the total weight of the composition (A).

18. The anode-forming composition (A) of claim 6, wherein the polymer binder is a carboxylated methyl cellulose.

19. The anode-forming composition (A) of claim 1, wherein
the silicon-containing electroactive material consists essentially of silicon or is a mixture of silicon and at least one carbonaceous material;
compound (M) of the metallic shell is selected from the group consisting of Cu, Ag and Ni; and
the chemical additive is selected from the group consisting of partially neutralized poly(acrylic acid) and poly(methacrylic acid), in a range between 0.5% and 5% by weight, with respect to the total weight of the composition (A).

20. The anode-forming composition (A) of claim 19, further comprising at least one polymer binder selected from the group consisting of: carboxylated alkyl cellulose; polyamide imides; and polyimides.
